(19) United States
(12) Patent Application Publication
(10) Pub. No.: US 2006/0224672 A1
(43) Pub. Date: Oct. 5, 2006

(54) "@" symbol for use in a multifunction device

(75) Inventors: Barry R. Cavill, Versilles, KY (US); James L. Combs, Lexington, KY (US); Joseph J. Wujick, St. Petersburg, FL (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/084,931

(22) Filed: Mar. 21, 2005

(51) Int. Cl. G06F 15/16

(52) U.S. Cl. 709/206

(57) ABSTRACT

Apparatus and methods for entering an email address using an @ symbol. The email address may be entered at a user interface having a display and a data input terminal. The email address is shown on the device display while the address is entered. An @ symbol may be displayed at or near a cursor representing a current character location. As a user enters the user name portion of the email address, the characters are displayed and the position of the cursor and @ symbol may be automatically advanced. Once the user name is entered, the user may then advance the position of the cursor to a domain name side of the @ symbol by entering a move command, such as by selecting a right arrow button. When the cursor is on the domain name side of the @ symbol, the position of the @ symbol may be fixed.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to devices incorporating a scan-to-email function, and more particularly to the entry of an email address into such devices.

2. Description of Related Art

Home office, small business, and enterprise office devices are consistently incorporating new functions. For example, “All-In-One” machines are configured to perform various tasks, such as printing, copying, scanning, and faxing. More recently, these multi-function devices have added email functionality, which allows end-users to email directly from a scanning device a copy of an image file representing a scanned document. Thus, the scan-to-email function may be implemented in devices traditionally incorporating an optical scanner such as a copier, scanner, facsimile, or the aforementioned “All-In-One” devices. The email function may also be incorporated in printer devices such as photo printers that have access to previously stored images. For example, many photo printers have a built in memory storage capability or have card readers adapted to access images previously stored on a memory card, such as from a digital camera or directly from the memory of a digital camera or a mass storage device.

The process of emailing an image file directly from these scanning or printing devices necessarily requires the entry of an email address. Unfortunately, one problem with conventional devices such as these is that the user interface is generally not optimized for the entry of email addresses. Some of these devices include a traditional 12-button telephone-type, alpha-numerical keypad comprising the numbers 0-9 as well as * and # buttons. These telephone-type keypads can be used to enter alphanumeric strings if the individual buttons are programmed to sequentially toggle between certain values on a display screen. For instance, the button corresponding to the number 2 may also be programmed to display the letters A, B, and C if the same button is repeatedly pressed. In this manner, an end user attempting to enter an email address at one of these devices has access to all numbers and all letters of the alphabet, albeit in an indirect manner.

An added problem related to the scan-to-email function is that email addresses may include special characters such as dashes (−), dots (•), and underscores (_). In fact, there is no limit to the combination of special and alphanumeric characters that may be combined to form an email address, especially when one considers that each email address is unique and many users may have multiple email addresses. Thus, unique character strings comprising numbers, letters, and characters are often used to create a unique email address. In an attempt to resolve the issue of inputting special characters, certain buttons of a conventional telephone-type keypad may be programmed to sequentially toggle through these special characters. For example, the * or # buttons may be programmed to generate a variety of special characters on a display screen, with different characters being displayed each time the same button is pressed. This process can certainly be time consuming considering the number of special characters available.

A common characteristic of all email addresses is that they contain a single “@” character that separates a user name or alias from a domain name (i.e., email addresses conform to the format username@domain). Thus, each time a user enters an email address, the @ symbol is used. As with other special characters, the @ symbol may be assigned to one particular button (e.g., the * or # button) and that button can be pressed until the @ symbol appears on the display. However, given that the @ symbol is used in every email address, it would seem that sequentially toggling through special characters to locate the @ symbol is unnecessarily burdensome.

### SUMMARY

The present invention is directed to a device and method of entering an email address that incorporates an @ symbol to eliminate the need to separately add the @ symbol. In one embodiment, the @ symbol may be incorporated on a multifunction device having a user interface comprising a display and a data input terminal. The data input terminal may be a telephone-type keypad. The user interface is adapted for entering an email address comprised of a user name and a domain name separated by the @ symbol. The multifunction device may include a data reader such as a scanner, memory card reader, a mass storage device reader that extracts attachment data to be sent in an email. The device may further include an email client adapted to transmit the attachment data with an email message addressed to the entered email address via a network such as the internet. The device may also have one or more processor circuits adapted to insert the @ symbol into the email address between the username and the domain name as the email address is entered.

The email address is shown on a device display while the address is entered. In one embodiment, the @ symbol may be displayed at or near a cursor representing a current character location. For instance, the cursor may be placed on a user name side of the @ symbol. As a user enters the user name portion of the email address, the characters are displayed and the position of the cursor and @ symbol are advanced to reflect the changed length of the user name. Once the user name is entered, the user may then advance the position of the cursor to a domain name side of the @ symbol by entering a move command, such as by selecting a right arrow button or key. If the cursor position is successfully moved to the domain name side of the @ symbol, the position of the @ symbol is fixed while the remainder of the email address (i.e., the domain name) is entered and displayed.

### BRIEF DESCRIPTION OF THE DRAWINGS

FIG. 1 is a perspective view of one embodiment of a multifunction device in which the present invention may be implemented;

FIG. 2 is a functional block diagram of a multifunction device according to one embodiment of the present invention;

FIG. 3 is a schematic diagram illustrating portions of a user interface panel of a multifunction device according to one embodiment of the present invention;

FIG. 4 is a functional block diagram illustrating the email functionality of a multifunction device according to one embodiment of the present invention;

FIG. 5 is a functional block diagram illustrating the email functionality of a multifunction device according to one embodiment of the present invention;

FIG. 6 is an exemplary display sequence shown on a display of a multifunction device according to one embodiment of the present invention;

FIG. 7 is an exemplary display sequence shown on a display of a multifunction device according to one embodiment of the present invention; and

FIG. 8 is a diagram of exemplary multifunction device processing logic to implement the @ symbol according to one embodiment of the present invention.

### DETAILED DESCRIPTION

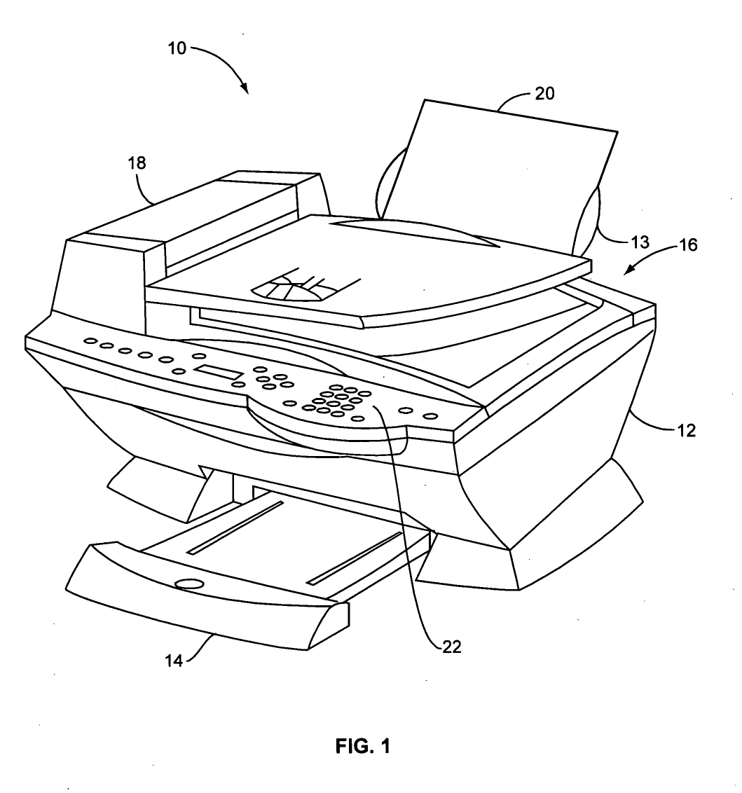

The present invention is directed to a device and method of entering an email address that incorporates an @ symbol. In one embodiment, the @ symbol may be incorporated on a device having a user interface comprising a display and a limited data input terminal. One application of the @ symbol is on a multifunction device as generally illustrated in FIG. 1. FIG. 1 depicts one embodiment of a representative multifunction device, such as an All-In-One (AIO) device, indicated generally by the numeral 10. The multifunction device 10 comprises a main body 12, at least one input media tray 13 holding one or more sheets of print media 20, a flatbed or feed-through scanner 16 as in known in the art comprising a document handler 18, a media output tray 14, and a user interface panel 22. The multifunction device 10 is adapted to perform multiple home or business office functions such as printing, faxing, scanning, and copying. Consequently, the multifunction device 10 includes further internal components, such as printer engine and printing cartridges, not visible in the exterior view shown in FIG. 1.

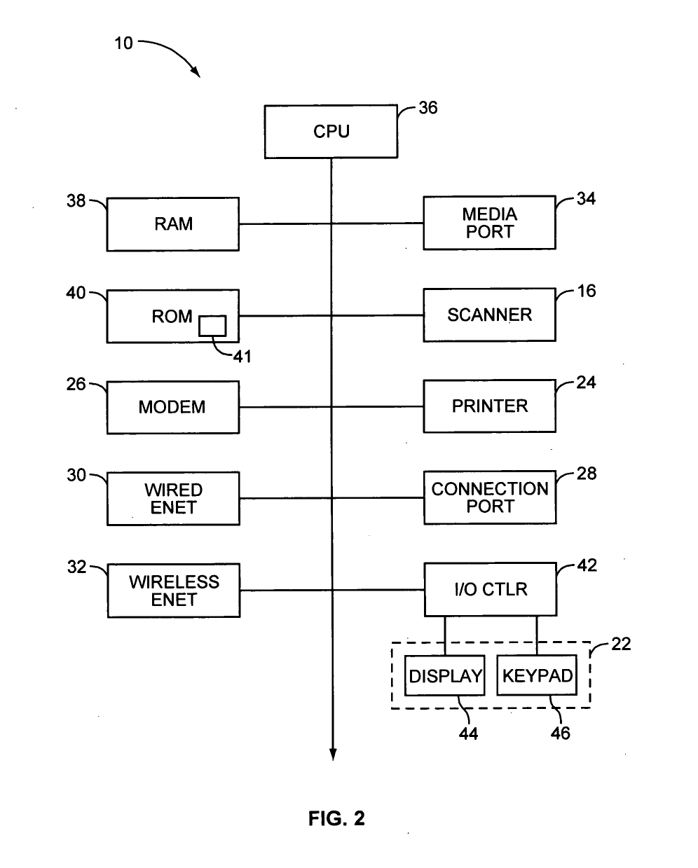

FIG. 2 provides a simplified representation of some of the various functional components of the disclosed multifunction device 10. For instance, the multifunction device 10 includes the previously mentioned scanner 16 as well as an integrated printer 24, which may itself include a conventionally known ink jet or laser-printer with a suitable document transport mechanism and printing cartridge. Interaction at the user interface 22 is controlled with the aid of an I/O controller 42. Thus, the I/O controller 42 generates user-readable graphics at a display 44 and interprets commands entered at an alpha-numerical keypad 46.

The multifunction device 10 also includes a modem 26, which may be a data modem to be used for dial-up internet access. In one embodiment, modem 26 is a fax modem compliant with commonly used ITU and CCITT compression and communication standards such as the V.XX and Class 1-4 standards known by those skilled in the art. The multifunction device 10 may also be coupled to a host computer (not shown) or external Ethernet adapter (also not shown) through a compatible connection port 28, which may comprise a standard serial data interface such as USB 1.1, USB 2.0, IEEE-1394 (including, but not limited to 1394a and 1394b) and the like.

The multifunction device 10 may also include integrated wired or wireless network interfaces 30, 32. The network interfaces 30, 32 permit operation of the multifunction device as a stand-alone device not expressly requiring a host computer to perform many of the included functions. The wired network interface 30 may comprise a conventionally known RJ-45 connector for connection to a 10/100 LAN or a 1/10 Gigabit Ethernet network. The wireless network interface 32 may comprise an adapter capable of wireless communications with other devices in a peer mode or with a wireless network in an infrastructure mode. Accordingly, the wireless network interface may comprise an adapter conforming to wireless communication standards such as a Bluetooth® interface, 802.11x, 802.15 or other standards known to those skilled in the art.

The multifunction device 10 may also include a media port 34, which may consist of a card reader, media reader or a serial port from which a user may access images, perhaps taken from a digital camera, for printing at the printer 24 or emailing as described below. The media port 34 may be adapted to accept common memory cards such as CompactFlash®, SmartMedia™, or Memory Stick™ memory cards. Alternatively, the media port 34 may accept a conventional adapter cable such as a USB or IEEE-1394 (Firewire) cable to access the contents of a digital camera or external storage devices, such as flash memory devices, card readers, or external hard drives. Further, the multifunction device 10 includes one or more processing circuits 36, system memory (RAM) 38, and flash memory for code storage (illustrated simply as ROM) 40. The memory devices 38, 40 may suitably comprise a variety of devices known to those skilled in the art such as SDRAM, DDRAM, EEPROM, Flash Memory, and perhaps a fixed hard drive. Those skilled in the art will appreciate and comprehend the advantages and disadvantages of the various memory types for a given application.

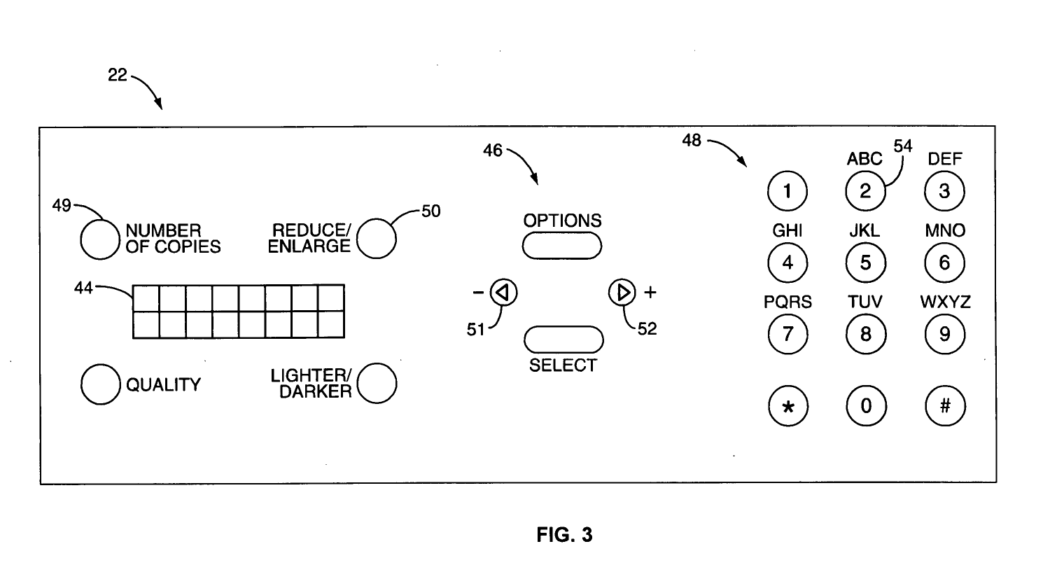

For operation as a stand-alone device, or as a device which is part of a computer network, or for operation with a host computer, the multifunction device 10 includes a user interface panel 22. A portion of an exemplary user interface panel 22 is shown in FIG. 3. As indicated above, the user interface panel 22 comprises a display 44 and a keypad 46, which includes an alpha-numerical keypad 48. In an exemplary embodiment, the alpha-numerical keypad 48 comprises a 12-button telephone-type keypad. The display 44 comprises a 2-line alphanumeric LCD display, though other types of displays ranging from single line displays to full color graphical displays are also contemplated. The telephone-type keypad 48 comprises buttons dedicated to the numbers 0-9 as well as the symbols * and # as found on a conventional telephone or facsimile device. Each of the individual buttons of the keypad 48 are also assigned other alphabetic or symbolic characters that are laid over the primary numerical value. That is, each button of the keypad 48 may be used to input four or more distinct characters. As an example, the number 2 button 54 may be repeatedly pushed to sequentially toggle through the number 2 and the letters A, B, C, a, b, and c. The remaining letters of the alphabet are similarly assigned to other numerical buttons 3 through 9 on the keypad 48. Special characters or operators (e.g., a space function) may be assigned in a similar manner to the 1, * and # buttons.

Referring still to FIG. 3, the user interface panel 22 may also include various other keys or buttons dedicated to device-specific functions. For example, buttons 49, 50 for controlling the number of copies and reduce/enlarge functions are used with a copy function of the multifunction device 10. Of particular relevance to the present invention are the directional buttons 51, 52, which control various context-specific menu functions as well as a cursor position on the display 44. Thus, a combination of the keypad 48, directional buttons 51, 52, and display 44 may be used to enter alphanumeric strings into the multifunction device 10.

In the present embodiment, one particularly relevant instance where an alphanumeric string is entered into the multifunction device 10 is while using an email function not previously described. As FIG. 2 illustrates, the multifunction device 10 may include multiple network interface devices, including wired and wireless network adapters 30, 32, a connection port 28 to external devices, such as a host computer (not shown) or Ethernet adapter (also not shown), and perhaps even a data modem 26 for dial-up network access. Accordingly, the multifunction device 10 may be used to transmit email messages to a network such as the Internet directly from the multifunction device 10.

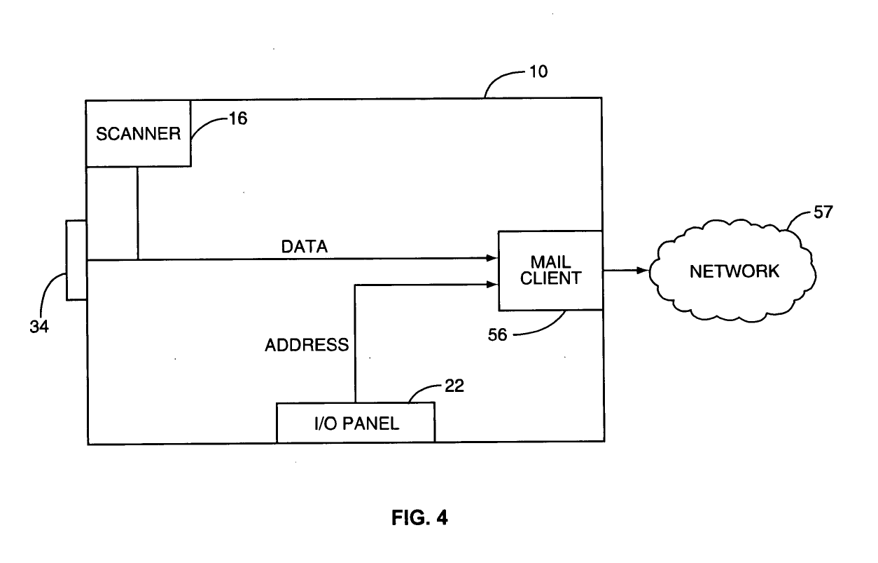

One application of this email function is to email data or image files obtained from the multifunction device 10. This operation is shown schematically in FIG. 4. For example, it may be desirable to email a scanned copy of a hardcopy photo or document. Accordingly, a user can place the document to be scanned and emailed in the scanner 16, which extracts a digital representation of the document. The digital version of the document may typically be in the form of an image file of a standard type. Some non-limiting examples include *.jpg, *.gif, *.tif, *.bmp, and *.pdf.

In parallel, the user selects an email mode and enters an appropriate email address at the user interface (or I/O) panel 22. A mail client 56 incorporated within the multifunction device 10 receives the image data from the scanner 16 as well as the destination email address from the user interface panel 22 and sends an email to the recipient over a network 57 via one of the aforementioned network interfaces (e.g., adapters 30, 32, modem 26). Alternatively, as described above and also as shown in FIG. 4, the multifunction device 10 may also include a media port 34 from which a user may access a data or image file to be sent via email from the multifunction device 10. Generally, the multifunction device 10 includes a data reader such as scanner 16 or media port 34 from which an email attachment may be created. Further, the mail client 56 is advantageously adapted to communicate with an electronic mail server using an appropriate mail standard. Suitable non-limiting examples include POP3, SMTP, LDAP Exchange, and IMAP. The email may be sent when an appropriate “Send” command is entered at the user interface panel 22.

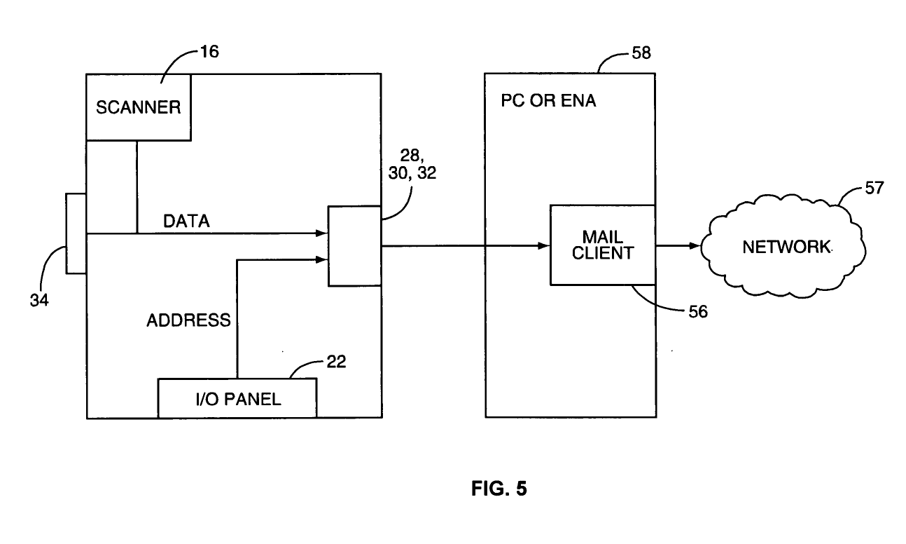

In an alternative embodiment of the multifunction device 10 shown in FIG. 5, the aforementioned mail client 56 may be incorporated in a separate device such as a host PC or dedicated Ethernet adapter 58. The data file obtained from scanner 16 or media port 34 is transmitted using one of the suitable interface adapters (e.g., connection port 28, or Ethernet adapters 30, 32) to the secondary device 58, where the email client 56 creates and sends an email having the attached data file to the addressee over a network 57. Those skilled in the art will appreciate other mechanisms for sending data or image files from a multifunction device 10 in addition to those disclosed herein.

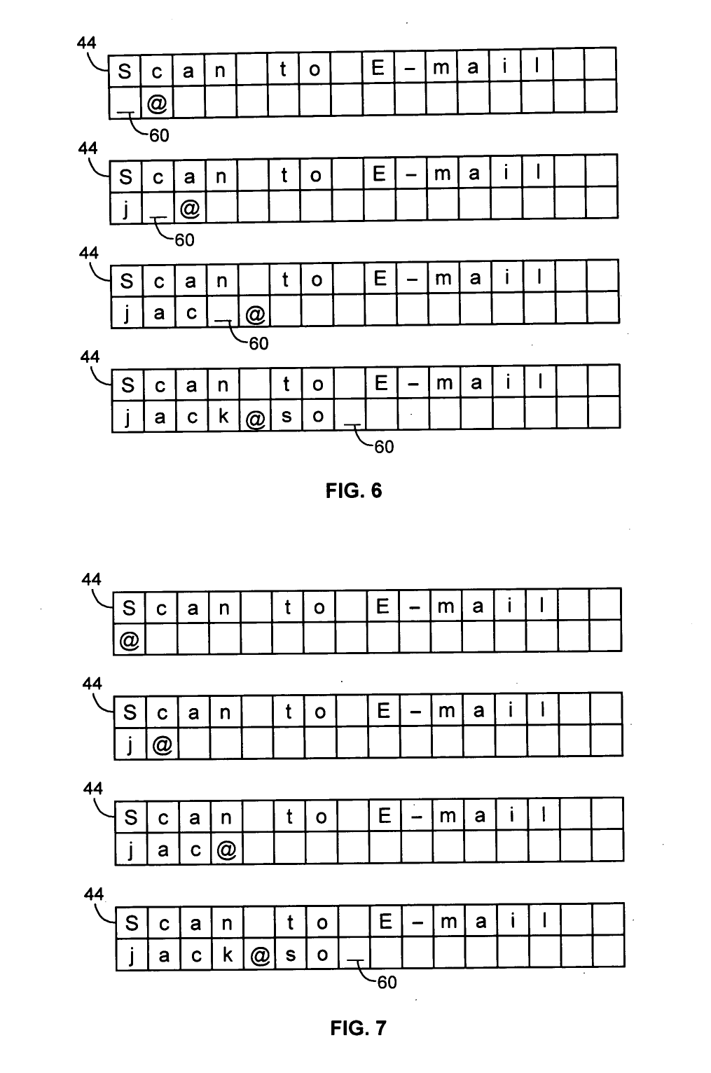

Inclusion of an @ symbol is described for one embodiment with reference to FIGS. 6-8. In general, the multifunction device 10 may operate as a stand alone unit that performs an email function, which requires that a user enter a valid email address. Email addresses generally conform to a standard format, which invariably includes the “@” symbol. Specifically, the email format conforms to the username@secondleveldomain.topleveldomain format, where the user name is a user-specific alias, the second level domain is a company, provider, or destination designator and the top level domain also call an extension is the type of organization such as “.com” for commercial, “.edu” for educational, “.gov” for governmental, etc. Other designators can also be provided for country location such as “uk” for the United Kingdom, “de” for Germany, etc. The combination of the top, second level domains, country designators etc. is also referred to as the domain name. A common limitation of the user interface panels 22 is the lack of a dedicated “@” symbol.

To circumvent this problem, one embodiment implements firmware code to add an @ symbol onto the operating panel display screen 44 at the time when an email address is entered. This @ symbol allows the user to enter an email address without having to select a dedicated @ key/button on an operating panel or toggle through a sequence of special characters. The typing sequence represented in FIG. 6 shows how the @ symbol operates. FIG. 6 shows a sequence of four separate stages, progressing in time, of entering an email address on display 44. The display 44 in FIG. 6 generally indicates that an exemplary “Scan to E-mail” mode is active and that an email address should be entered. The display 44 may also exhibit other modes in which an email address is to be entered, such as a “Copy to E-mail” mode, or simply an “E-mail” mode. As discussed above, the “Scan” function may include scanning a document with a scanner 16 or accessing a pre-existing data file from a media card, external storage device, or digital camera via media port 34. The various embodiments disclosed herein also contemplate the ability to mail multiple data files as multiple attachments to a single email. Initially, the @ symbol is placed to the right of and adjacent to the cursor position, which is indicated by the underscore (_) symbol 60 as shown in the top row of FIG. 6. As new characters are added (using the input pad 48 shown in FIG. 3) at the cursor position, the cursor and the @ symbol remain adjacent to one another, with both shifting or indexing to the right as shown in the second and third rows of FIG. 6. Once the email recipient's username or alias (i.e., first part) is entered, the cursor 60 is moved to the right side of the @ symbol to continue entering the domain name as shown in the fourth or bottom row of FIG. 6. In one embodiment, the “Right Arrow” button/key (item 52 in FIG. 3) is pressed to move the cursor in this manner. Various inputs may be assigned to move the cursor for entering the domain name. In the example shown in FIG. 6, the user enters the following keystrokes to reach the position indicated in the last part of the sequence:
j a c k→s o

The precise relative positioning of the cursor and the @ symbol may be altered without deviating from the underlying concept. In one embodiment referred to as a “floating” @ symbol, the cursor and the @ symbol remain adjacent to one another as new characters are added with both shifting or indexing to the right. In another embodiment contrasted with the embodiment shown in FIG. 6 where the @ symbol is positioned immediately to the right of the cursor, one or more empty character slots may be placed between the @ symbol and cursor. Similarly, as shown in FIG. 7, the cursor and the @ symbol may be simultaneously placed in the same position (see the top row of FIG. 7) while the username is entered, with the cursor 60 separating from the @ symbol when the user-directed move command and domain name are entered as shown in the fourth or bottom row of FIG. 7. In another embodiment, the field to the left of the @ symbol is some predetermined size that is able to receive the username. The @ symbol may remain stationary at a fixed position as the username is entered. The appropriate username is then entered and the cursor location is moved to the right of the @ symbol to enter the domain name. Cursor location is controlled with the existing directional buttons 51, 52 shown in FIG. 3. Thus, additional programming is not likely needed to control cursor position. Further, no additional programming to assign the @ to one of the 12 buttons in the keypad 48 or other buttons in keypad 46 is required.

Editing an email address is accomplished by moving the cursor to the desired position using the directional buttons 51, 52 and re-typing the desired characters. Thus, if a user has moved the cursor to the domain name side of the email address (thereby fixing the position of the @ symbol), the username may still be edited by moving the cursor back to the username side of the @ symbol. In doing so, the position of the @ symbol is unlocked. Deleting characters from the username moves the @ symbol to the left and the addition of characters moves the @ symbol to the right. Then, when the cursor is moved once again to the domain name side of the email address, the @ symbol location is once again fixed.

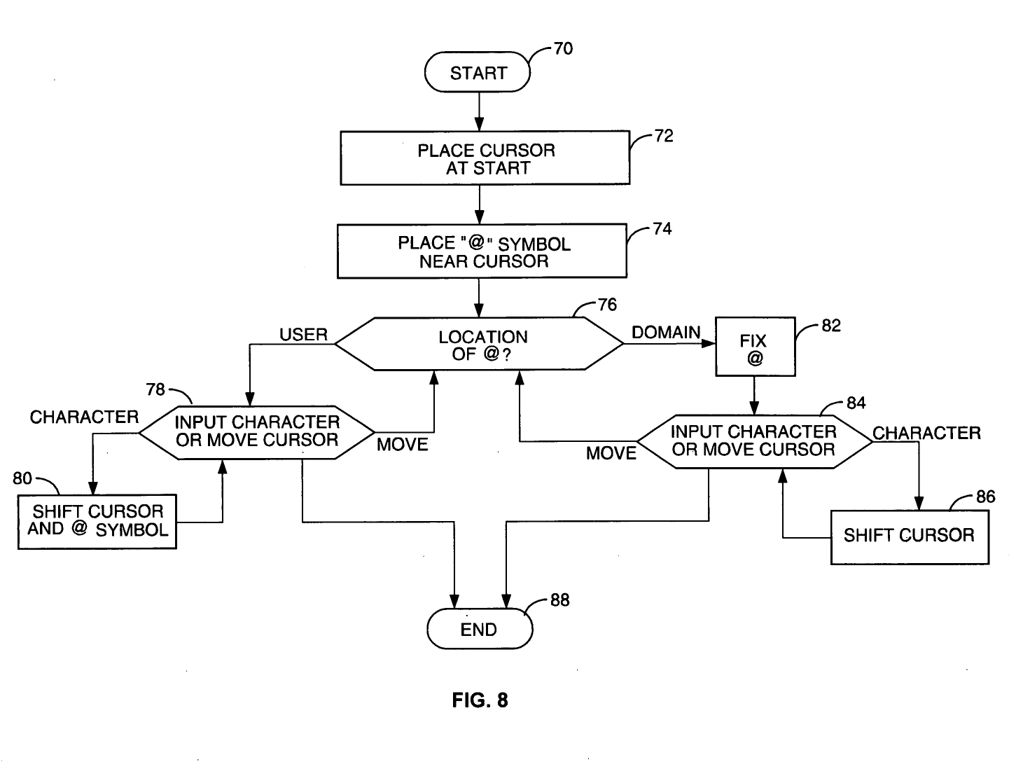

The above description of the editing process highlights a more general functionality of the present embodiment. That is, when the cursor is on a username side of the email address, the @ symbol floats to adapt to the length of the username. Then, when the cursor is on a domain name side of the email address, the @ symbol is fixed in place. This function is more clearly shown in FIG. 8, which provides a general diagram of one embodiment of the process.

The routine shown in FIG. 8 is started 70 when the multifunction device 10 is placed in an email mode and the user is instructed to enter an email address. Initially, at step 72, the cursor is placed at an initial position in the email address field. In a separate or concurrent step 74, the @ symbol is placed at or near the cursor position. The routine then waits for user action and determines the appropriate steps to take based on the location of the @ symbol. Initially, the cursor is placed on the username side of the @ symbol. Thus, at decision step 76, the left branch is taken and the routine waits for the entry of a new character (for the username) or a move command (such as moving to the domain side). If characters are entered at decision step 78, the routine shifts or “floats” (step 80) the cursor and @ symbol in tandem to the right to accommodate the new username length. The routine then waits for the next user action. The process may be repeated until the username is successfully entered.

If the cursor position is moved to the right of the @ symbol, the right branch at decision step 76 is taken. The @ position is fixed at step 82. Then, as before, the routine waits for the entry of a new character (for the domain name) or a move command (such as moving to the username side). If characters are entered at decision step 84, the routine, at step 86, shifts the cursor to the right (the @ symbol remains fixed) to accommodate the new domain name length. The routine then waits for the next user action. The process may be repeated until the domain name is successfully entered. In addition, the cursor position may be moved back and forth between the username and domain name sides of the @ symbol to edit the email address as desired and as described above. Furthermore, the process may be terminated 88 from either of the decision steps 78 or 84 by selecting an end/send/confirm option (not shown) on the multifunction device 10.

Those skilled in the art should appreciate that the illustrated circuits shown in FIG. 3 for implementing the present invention may comprise hardware, software, or any combination thereof. For example, the @ symbol circuit 41 may be a separate hardware circuit, or may be included as part of other processing hardware. More advantageously, however, the @ symbol circuit 41 is at least partially implemented via stored program instructions for execution by one or more microprocessors 36, digital signal processors (DSPs), ASICs or other digital processing circuits included in the multifunction device 10.

The present invention may be implemented in, but is not limited to, similar devices not having a QWERTY-type alphanumeric keyboard. QWERTY-type keyboards are full size keyboards, such as that used with laptop, desktop, and certain handheld computers, that have a dedicated button for each letter of the alphabet. In these full size keyboards, the @ symbol is commonly overlaid on the number 2 button and entered by simultaneously selecting the SHIFT and number 2 button. That said the present invention may certainly be incorporated in devices that do and do not have full size keyboards, though the advantages of doing so in the latter is more readily apparent. Thus, in addition to the implementation described herein for use with a multifunction device 10, the present invention may also be incorporated in a variety of devices such as computer systems, personal digital assistants or PDAs, Blackberry® devices and mobile communication devices such as cellular phones. Another application of the disclosed embodiments is with devices used at point of sale terminals. Some exemplary embodiments include self-serve retail sales kiosks and automated teller machines. With these types of devices, the simplified email entry may advantageously persuade end-users to email copies of transactions to themselves in an effort to eliminate paper copies.

Furthermore, the present invention may be carried out in other specific ways than those herein set forth without departing from the scope and essential characteristics of the invention. For instance, the embodiments described have been depicted in use with a separate display 44 and input keypad 48. In other devices, a touch pad display may be used such that the output display and the input device may be one and the same. The present embodiments are, therefore, to be considered in all respects as illustrative and not restrictive, and all changes coming within the meaning and equivalency range of the appended claims are intended to be embraced therein.

What is claimed is:

1. A method of addressing electronic mail at a user interface, the method comprising:
displaying an @ symbol on a display associated with said user interface;
displaying a cursor representing a current character location on a first side of the @ symbol;
displaying characters of a first portion of said electronic mail address that are entered using a data input interface associated with said user interface;
advancing the position of the cursor to a second side of the @ symbol in response to a move command received from the data input interface;
fixing the location of the @ symbol when the position of the cursor is on the second side of the @ symbol; and
displaying characters of a second portion of said electronic mail address that are entered using the data input interface.

2. The method of claim 1 further comprising advancing the position of the @ symbol after each of the characters of the first portion are entered.

3. The method of claim 1 wherein fixing the location of the @ symbol when the position of the cursor is on the second side of the @ symbol comprises fixing the @ symbol after end of the first portion and before the start of the second portion.

4. The method of claim 1 further comprising transmitting the electronic mail to a remote device having the electronic mail address upon receiving a send command from the data input interface.

5. The method of claim 4 further comprising creating an attachment file and transmitting the attachment file in the electronic mail to the electronic mail address.

6. The method of claim 5 wherein the step of creating the attachment file comprises scanning an image of a document.

7. The method of claim 1 further comprising entering the electronic mail address at a scanner device.

8. The method of claim 1 further comprising associating the move command with a right arrow button.

9. The method of claim 1, further comprising entering a user name on the first side of the @ symbol and entering a domain name on the second side of the @ symbol.

10. A method of generating an email address at a user interface of a multifunction device, the method comprising:
displaying an @ symbol near a current cursor position on a display associated with said user interface;
displaying individual characters of said email address at the current cursor position on the display as the characters are input;
indexing the current cursor position and the @ symbol position after the input of each of the individual characters while the current cursor position is on a first side of the @ symbol; and
fixing the position of the @ symbol and indexing the current cursor position after the input of individual characters of said email address while the current cursor position is on a second side of the @ symbol.

11. The method of claim 10 further comprising changing the current cursor position from the first side of the @ symbol to the second side of the @ symbol in response to receiving a move command.

12. The method of claim 10 further comprising changing the current cursor position from the first side of the @ symbol to the second side of the @ symbol in response to receiving a right arrow input.

13. The method of claim 10 further comprising displaying a user name on a left side of the @ symbol and displaying a domain name on a right side of the @ symbol.

14. The method of claim 10 further comprising displaying the current cursor position and the position of the @ symbol adjacent to one another.

15. The method of claim 10 further comprising displaying the current cursor position and the position of the @ symbol at a common location.

16. The method of claim 10 further comprising receiving the individual characters through an alpha-numerical keypad.

17. A multifunction device comprising:
a user interface having an associated display and an associated data input interface adapted to generate an email address comprised of a user name and a domain name separated by an @ symbol;
a data reader that extracts attachment data;
an email client adapted to transmit the attachment data with an email message to the email address via a network; and
one or more processor circuits adapted to automatically insert the @ symbol into the email address between the username and the domain name.

18. The multifunction device of claim 17 wherein the data reader comprises one of a scanner, a memory card reader, and a mass storage device reader.

19. The multifunction device of claim 17 wherein the data input interface comprises an alpha-numerical keypad.

20. The multifunction device of claim 17 wherein the one or more processor circuits is adapted to continually display the @ symbol and automatically move the position of the @ symbol to the end of the user name as the user name is entered at the data input interface.

21. The multifunction device of claim 21 wherein the one or more processor circuits is further adapted to lock the position of the @ symbol at the end of the user name and before the domain name as the domain name is entered at the data input terminal.

22. The multifunction device of claim 17 wherein the user interface is associated with one of a point of sale terminal, a computer system, a personal digital assistant, a Blackberry® devices, and a mobile communication device.
